(19) United States
(12) Patent Application Publication
(10) Pub. No.: US 2018/0051737 A1
(43) Pub. Date: Feb. 22, 2018

(54) HIGH PERFORMANCE THREAD ROLLING AND THREAD LOCKING FASTENER

(71) Applicant: Research Engineering & Manufacturing Inc., Middletown, RI (US)

(72) Inventor: Bobby Lee Budziszek, Middletown, RI (US)

(21) Appl. No.: 15/671,737

(22) Filed: Aug. 8, 2017

Related U.S. Application Data
(60) Provisional application No. 62/376,704, filed on Aug. 18, 2016.

(51) Int. Cl. F16B 39/284

(52) U.S. Cl. CPC F16B 39/284

(57) ABSTRACT

A thread rolling and self locking fastener is provided. A thread rolling external thread is disposed along the shaft of the fastener. A non-continuous core thread is also disposed thereon.

### PRIORITY CLAIM

The present application claims priority to U.S. Provisional Patent Application Ser. No. 62/376,704, filed on Aug. 18, 2016, entitled HIGH PERFORMANCE THREAD ROLLING AND THREAD LOCKING FASTENER, by Bobby Lee Budziszek, the contents of which are hereby incorporated by reference.

### TECHNICAL FIELD

The present disclosure relates to thread rolling fasteners and, more particularly, to thread rolling and thread locking fasteners.

### BACKGROUND INFORMATION

High-performance thread rolling fasteners, i.e. fasteners that form internal threads in a bolt, have been utilized for many years. Similarly, thread locking fasteners have also been utilized as fastener systems for many years. Examples of prior fasteners that relate to the individual functions of thread rolling fasteners or thread locking fasteners are described in, for example, U.S. Pat. No. 6,089,806, entitled BLANK FOR SELF-TAPPING FASTENER, U.S. Pat. No. 5,722,808, entitled THREADED FASTENER SYSTEM, and U.S. Pat. No. 4,351,626 entitled SELF-LOCKING THREADED FASTENER, the contents of each are hereby incorporated by reference.

FIG. 1 is an exemplary lateral view of a self locking fastener and nut combination 100 as is currently known in the art. The fastener comprises of a head 105, an unthreaded shank portion 115, and a threaded shank portion 110. The threaded shank portion operatively interacts with a threaded nut member 120 to form a self locking fastener combination. Typically, the threaded portion 110 includes a special thread design that produces a firm metal to metal contact and that works to prevent a lateral movement of the fastener and nut relative to each other with concomitant loosening of the fastener when subject to vibrational forces.

FIG. 2 is an exemplary lateral view of an exemplary thread rolling fastener 200 as is currently known in the art. The fastener 200 comprises a head 205 having a base 210. A shank 225 extends therefrom having a threaded portion 215 and a thread rolling portion 225. The thread rolling portion 225 is illustratively designed to form appropriate threads in material, such as an unthreaded nut member (not shown) when appropriate rotational forces are applied to the fastener 200 via the head 205. The fastener may be as defined in SAE-J1237 1979, the contents of which are hereby incorporated by reference.

As noted above, fasteners that have self locking capabilities are known in the art. Similarly, thread rolling fasteners are also known in the art. However, there does not exist a fastener that is both thread rolling and self-locking. It is desirous to have a single fastener having both features as it may simplify design choices.

### SUMMARY

The noted disadvantages of the prior art are overcome by providing a thread rolling and self locking fastener (screw). The screw (or other fastener) provides high performance thread rolling capabilities and also a mechanical locking feature that illustratively produces alternating sequential interference between the newly formed thread in the nut (or other material) based on the novel design of the screw thread. The locking element (core thread) is unlike prior art systems that rely upon pressure forces located at mating surfaces. Instead, a locking element on the fastener develops thread interfaces by reforming the nut thread material around the fasteners core to provide for mechanical interface to resist loosening tendencies that may occur due to external (e.g., vibrational) forces applied to the fastener-nut assembly.

The locking element comprises a core thread having a smaller diameter than the external thread of the fastener. The core thread is not continuous along the body of the fastener. In operation, the locking element, or core thread, deforms previously created internal threads that results in an internal pressure area being created. This causes only a section of the internal thread to deform; however, the fully formed external threads and internal threads act as a pinch, which creates internal locking. After the locking element deforms a section of the internal thread, the external thread of the fastener will reform the internal thread. As the locking elements are not continuous, upon removal of the fastener, the external threads will reform the internal threads to their original shape, thereby permitting reuse of the nut member.

A similar principle applies when using pre-tapped nut members. When the fastener is being inserted, the external threads will follow the internal threads, while the locking element will deform the internal thread. The external threads will maintain and reform the internal threads during insertion and removal.

### BRIEF DESCRIPTION OF THE DRAWINGS

The above and further advantages of the present invention are described herein in relation to the accompanying drawings in which like reference numerals indicate identical or substantially identical elements:

FIG. 1, previously described, is a lateral view of an exemplary self locking fastener assembly;

FIG. 2, previously described, is a lateral view of an exemplary thread rolling fastener;

FIG. 3A is a lateral view of an exemplary thread rolling and self locking fastener in accordance with an illustrative embodiment of the present invention;

FIG. 3B is a lateral view of an exemplary thread rolling and self locking fastener illustrating the placement of the locking element (core thread) in accordance with an illustrative embodiment of the present invention;

FIG. 4 is a diagram illustrating exemplary thread profiles of an external thread and a core thread in accordance with an illustrative embodiment of the present invention;

FIG. 5A is a longitudal cross-section view of an exemplary thread rolling and self locking fastener in accordance with an illustrative embodiment of the present invention;

FIG. 5B is a lateral cross-section view of an exemplary thread rolling and self locking fastener in accordance with an illustrative embodiment of the present invention;

FIG. 5C is a lateral cross-section view of an exemplary thread rolling and self locking fastener in accordance with an illustrative embodiment of the present invention;

FIG. 6A is a partial side view of a fastener in accordance with an illustrative embodiment of the present invention;

FIG. 6B is a partial side view of an exemplary fastener illustrating the beginning of a core thread in accordance with an illustrative embodiment of the present invention;

FIG. 6C is a partial side view of an exemplary fastener illustrating a core thread in accordance with an illustrative embodiment of the present invention;

FIG. 6D is a partial side view of an exemplary fastener illustrating a core thread in accordance with an illustrative embodiment of the present invention;

FIG. 7 is a cross-sectional diagram illustrating an exemplary fastener in an unthreaded nut member in accordance with an illustrative embodiment of the present invention; and

FIG. 8 is a cross-sectional diagram illustrating an exemplary fastener in a threaded nut member in accordance with an illustrative embodiment of the present invention.

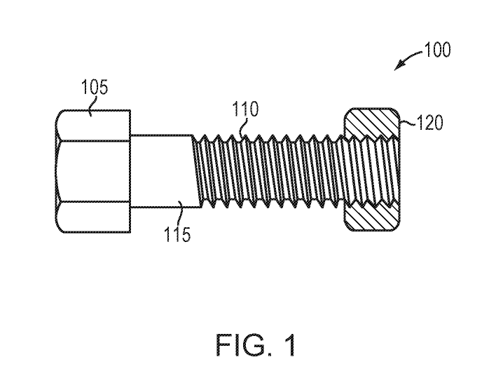

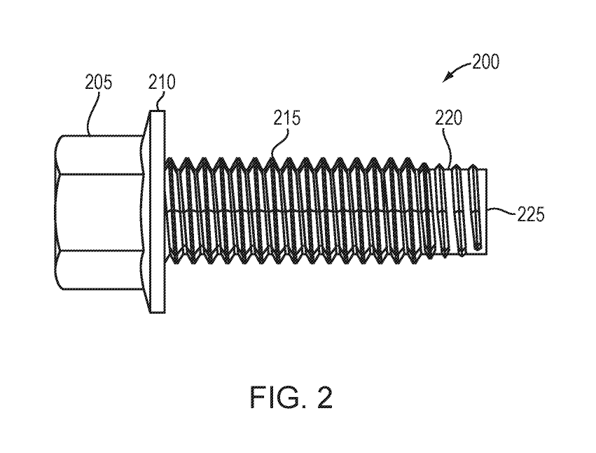

### DETAILED DESCRIPTION OF AN ILLUSTRATIVE EMBODIMENT

The present invention provides am exemplary thread rolling and self-locking fastener. A thread rolling external thread is illustratively utilized on the fastener. A plurality of novel locking elements, comprising a core thread, are disposed between the external threads at non-continuous locations along the shank of the fastener to provide the locking functionality. The core threads deform the nut material to provide a self-locking functionality. The external threads reform the internal threads of a nut to enable the nut to be reused.

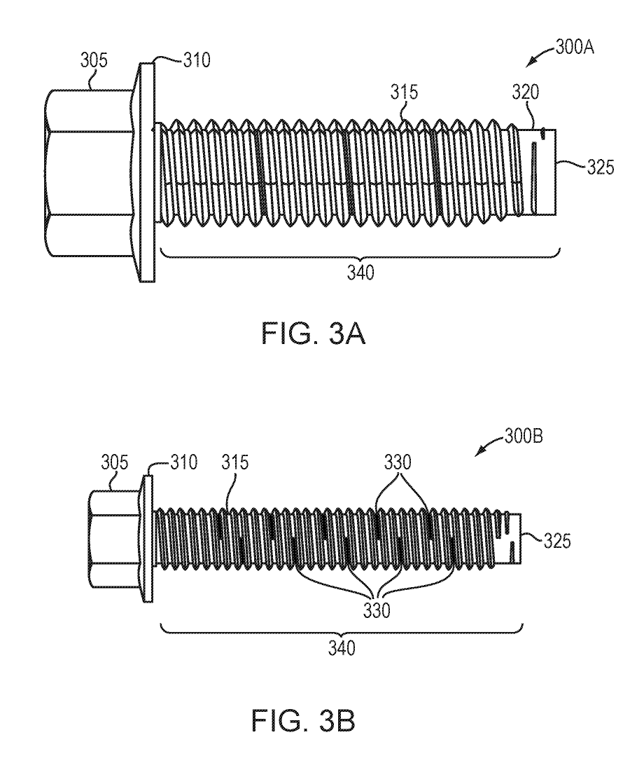

FIG. 3A is a lateral view of an exemplary fastener 300A in accordance with an illustrative embodiment of the present invention. The fastener 300A illustratively comprises a head 305 having a base 310. From the base 310, a shank 340 extends along the axis of the fastener to a fastener end 325. Along a portion of the shank 340 is disposed an exemplary helical thread 315 having an external thread. Illustratively, the helical thread 315 comprises the thread for a thread rolling screw as defined in the above-incorporated SAE-J1237 1979 and may have thread sizes as defined in IFI 510, which are hereby incorporated by reference. The shaft 340 also illustratively comprises a tapered lead entry portion 320 that may be utilized to set the fastener within a nut member (not shown) in accordance with alternative embodiments of the present invention. Illustratively, exemplary locking elements (core threads) 330 may be dispersed along the portion of the shank 340 having the helical thread 315 to provide the novel locking capabilities, as described further below.

As will be appreciated by those skilled in the art, the head 305 illustratively comprises appropriate mechanisms to be engaged by a tool, such as a screwdriver, etc. to impart rotational forces on it for purposes of insertion/removal from a nut member. The head 305 may utilize any type of mechanism for being engaged by a tool. The shank 340 may have a substantially circular cross-section or may have an alternative cross section, such as one having three lobes such as that described in the above referenced U.S. Pat. No. 6,089,806.

FIG. 3B is an exemplary lateral view of a fastener 300B in accordance with an illustrative embodiment the present invention. As illustrated in FIG. 3B, a plurality of locking elements 330 are disposed along the shank 340. The locking elements are illustratively embodied as a core thread, described further below. It should be noted that the terms locking element and core thread may be used interchangeably within this description. In accordance with an illustrative embodiment of the present invention, the locking elements 330 are disposed at intervals so that a nut member will always be engaged along the length of the shank. Illustratively, the locking elements are positioned along 340 so that no two core threads are positioned closer than approximately two times the thread pitch (i.e., distance between crests of adjacent threads) of the external thread 315. It should be noted that this is an exemplary distance and, in alternative embodiments of the present invention, the distance between locking elements 330 may be greater and/or less than two times the pitch of the external thread. Further, while the present description is written in terms of the locking elements being non-continuously distributed long the shank, in alternative embodiments of the present invention, the locking elements may be substantially evenly and/or continuously distributed along the shank. Thus, the number and frequency of locking elements 330 may vary among differing fasteners based on design choices for the type and thickness of a nut member. As such, the description and illustration of occurrences of locking members 330 in FIGS. 3A, B should be taken as exemplary only.

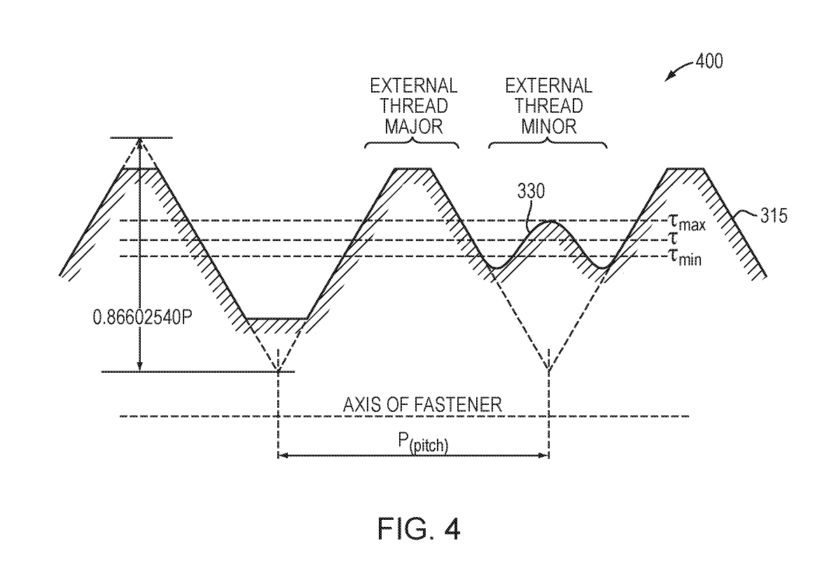

FIG. 4 is a diagram illustrating exemplary thread profiles of an external thread 315 and a core thread 330 in accordance with an illustrated embodiment of the present invention. The lowest points between to threads are separated from each other by pitch P, i.e., at any point along a thread, the corresponding location of the next thread will be a distance P away. Illustratively, the external threads do not have completely triangular cross-sections, but are instead truncated. Illustratively, the height of a non-truncated external thread is approximately 0.8660254 the height of P. It should be noted that in alternative embodiments, the height of the external threads may vary depending on design choices. As such, the height used herein should be taken as exemplary only.

FIG. 4 illustrates three metrics:

Tmax=0.40714×P

T=0.433013×P

Tmin=0.37886×P.

It should be noted that these values are illustrative and may vary in alternative embodiments of the present invention. T is illustratively the measurement where the minor thread pitch diameter and the major thread pitch diameter are aligned. Tmax is illustratively the upper measurement of the minor thread approximately ½ a pitch diameter tolerance above T. Similarly, Tmin is illustratively the lower measurement of the minor thread approximately ½ a pitch diameter tolerance below T.

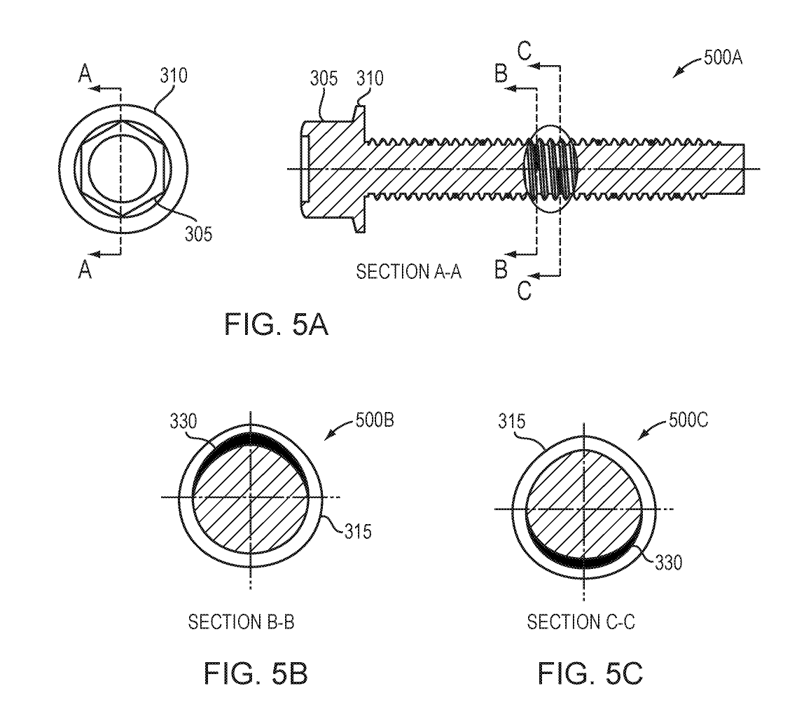

FIG. 5A is an exemplary cross sectional view of an exemplary fastener 500 A in accordance with an illustrative embodiment of the present invention. FIG. 5A shows a longitudinal view of an exemplary fastener along diameter line A-A. FIG. 5B is a lateral view of an exemplary faster 500B along line cross sectional line B-B from FIG. 5A. FIG. 5C is an exemplary cross-sectional view 500C of a fastener in accordance with an illustrative embodiment the present invention along line C-C of FIG. 5A. The cross-sectional views 500B, C show exemplary external thread outline 315 as well as locking element 330. As can be seen from exemplary cross sections 500B, C, the core thread 330 rotates along the portion of the shank and does not exceed the diameter of the external thread 315. It should be noted that exemplary cross-section 500B,C is of an illustrative three lobed cross sectional design. It should be further noted that in alternative embodiments of the present invention, differing cross-sections may be utilized to achieve the goals of the present invention. As such, the description of a three-lobed cross section should be taken as exemplary only.

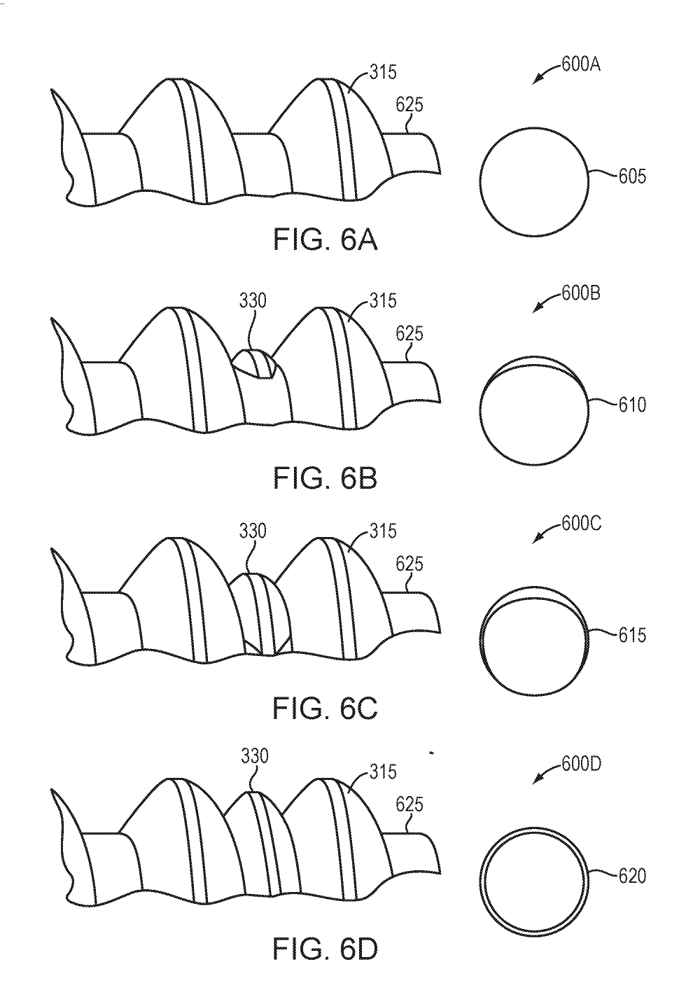

This is further illustrated in FIGS. 6A-D, described herein. FIG. 6A is an exemplary lateral view and cross section 600A of a fastener in accordance with an illustrative embodiment of the present invention. Cross-sectional view 605 illustrates the diameter of external threads 315 has can be as can be seen from FIG. 6A. At the particular point along the fastener, there are no locking elements. However, in a FIG. 6B, a locking element 330 has begun to appear within the spaces between external threads 315. As the fastener is continued to be rotated, the locking element 330 continues to increase in size as illustrated in FIG. 6C. This continues in FIG. 6D where the locking element 330 reaches its maximum size between external threads 315.

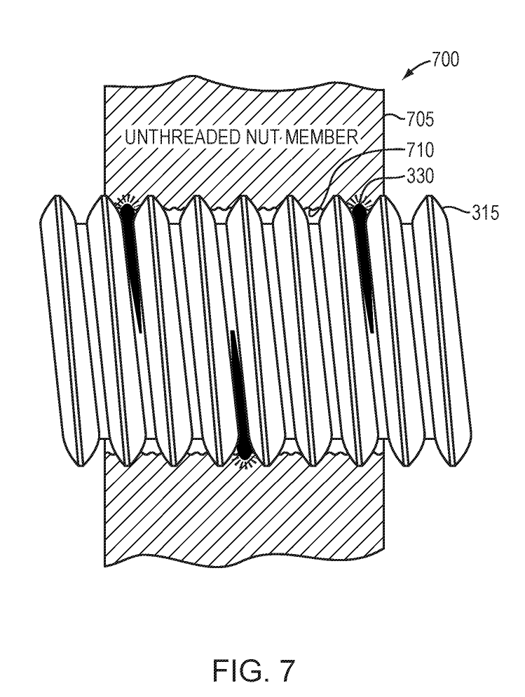

FIG. 7 is a cross-sectional view of an exemplary unthreaded nut number 705 having an exemplary fastener inserted in accordance with an illustrative embodiment of the present invention. The exemplary nut 705 is illustrated whereas a cross-sectional view of the nut is illustrated showing unthreaded nut portion 705 as well as an interior edge 710 of the nut member 705. Threads 315 form appropriate internal threads of the unthreaded nut member in accordance with an illustrative embodiment of the present invention. Further locking elements 330 deform the unthreaded nut member as described above to create a locking mechanism.

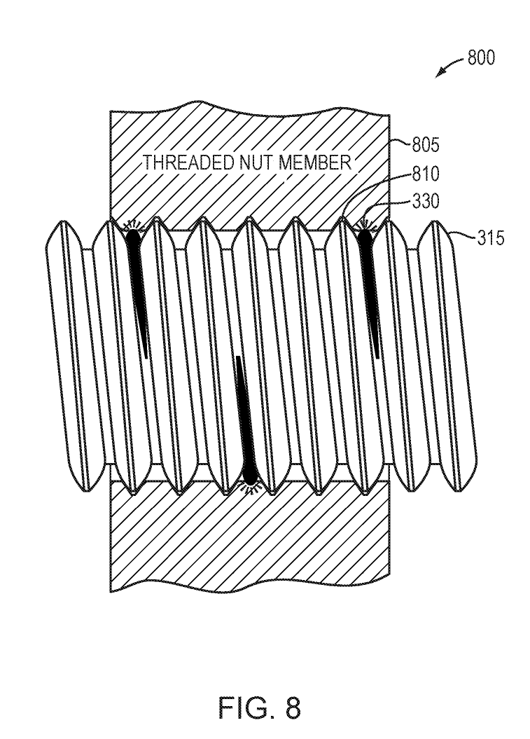

FIG. 8 is an exemplary cross-sectional view of a fastener inserted into a threaded nut member 805 having internal threads 810 in accordance with an illustrative embodiment of the present invention. The locking members 330 are shown deforming the nut member 805 to create the locking mechanism.

The present description is written in terms of various illustrative embodiments of the present invention. As will be appreciated by those skilled in the art, various modifications may be made to the embodiments described herein without departing from the spirit or scope of the invention. As such, the described embodiments should be taken as illustrative only.

What is claimed is:

1. A fastener comprising:
a head from which a shank extends in a first axis, the shank having a thread rolling helical thread formed thereon; and
one or more core threads disposed along the shank.

2. The fastener of claim 1 where in the shank has a circular cross section.

3. The fastener of claim 1 wherein the shank has cross section having three lobes.

4. The fastener of claim 1 wherein the one or more core threads are spaced approximately a width of a nut member apart along the shank.

5. The fastener of claim 1 wherein the one or more core threads are disposed between threads of the thread rolling helical thread along the shank.

6. A fastener comprising:
a shank extending along a first axis, a head connected to a first end of the shank, the head extending perpendicular to the first axis, wherein the head is configured to accept a driving force;
a first thread disposed along the shank from the head to substantially a second end of the shank, the first thread configured to form internal threads in a nut member;
a second thread disposed along one or more portions of the shank, the second thread forming material of the nut member into a locking mechanism when the fastener is inserted into the nut member.

7. The fastener of claim 6 wherein the second thread reforms material of the nut member when the fastener is removed.

8. The fastener of claim 6 wherein the first thread is a self tapping thread.

9. The fastener of claim 6 wherein the second thread is substantially periodic along the shank from the head to the second end of the shank.

10. A system comprising:
a fastener having a first thread and a second thread disposed thereon, the first thread being a thread rolling thread and the second thread being a core thread; and
a nut member, the nut member being deformed by the second thread upon insertion so that the fastener and nut member are locked and wherein the nut member is reformed by the second thread upon removal.
